(19) United States
(12) Patent Application Publication
(10) Pub. No.: US 2025/0356161 A1
(43) Pub. Date: Nov. 20, 2025

(54) AUTOMATED DISCOVERY OF AGENTS IN SYSTEMS

(71) Applicant: DeepMind Technologies Limited, London (GB)

(72) Inventors: Zachary Alex Kenton Jebreel, London (GB); Ramana Kumar, London (GB); Jonathan George Richens, London (GB); Tom Åke Helmer Everitt, London (GB); Aiken Sebastian Farquhar, London (GB); Matthew Joseph Tilley MacDermott, London (GB)

(21) Appl. No.: 18/872,327

(22) PCT Filed: Aug. 8, 2023
(86) PCT No.: PCT/EP2023/071987

§ 371 Date: Dec. 6, 2024

Related U.S. Application Data
(60) Provisional application No. 63/396,074, filed on Aug. 8, 2022.

(51) Int. Cl. G06N 3/04; G06N 3/092

(52) U.S. Cl. CPC G06N 3/04; G06N 3/092

(57) ABSTRACT

Methods, systems, and apparatus, including computer programs encoded on a computer storage medium, for identifying agents in a system. According to one aspect, a method comprises: generating data defining a causal model of the system, comprising transmitting instructions to cause a plurality of interventions to be applied to the system, wherein each intervention modifies one or more variable elements in the system; processing the model of the system to identify one or more of the variable elements in the system as being decision elements, wherein each decision element represents an action selected by a respective agent in the system; and identifying one or more agents in the system based on the decision elements; and outputting data that identifies the agents in the system.

### BACKGROUND

This specification relates to automatically identifying agents in systems.

An agent in a system can be an entity that performs actions in the system, e.g., actions to interact with the system to accomplish an objective. In some situations, systems can behave in undesirable ways, e.g., by pursuing goals different from those envisioned by system designers.

### SUMMARY

This specification generally describes an agent identification system implemented as computer programs on one or more computers in one or more locations that perform operations to identify agents in “target” systems. In some cases, “agents” can be understood as entities whose outputs are moved by reasons. For instance, the reason that an agent performs a particular action or decision may be that the agent expects the action to precipitate a certain outcome which the agent finds desirable. This desirability can be represented by the agent's “utility,” which represents an optimization target for the one or more agents in the system, i.e., agents take actions to maximize utility. The described techniques are useful for building machine learning and other systems that pursue the intended design goal(s), e.g. to improve safety, fairness, and robustness or stability.

In particular, an agent can be an entity that interacts with the target system by performing actions that are selected in accordance with an action selection policy. In particular, an agent can be an entity that adapts its action selection behavior in response to changes in how the actions performed by the agent affect the target system. These feature distinguishes agents from other entities, whose output might accidentally be optimal for producing a certain outcome. For example, a rock that is the perfect size to block a pipe is accidentally optimal for reducing water flow through the pipe. If the environment changes, then an agent in the environment may adapt in order to maximize utility. In contrast, the rock would not adapt if the pipe was wider, and for this reason a rock cannot be an agent.

Thus an agent can have an action selection policy that is conditioned on the state of the target system. In some cases, an agent can implement an action selection policy that is parameterized by a set of parameters having values that are learned using machine learning techniques. For instance, an agent can implement an action selection policy that is parametrized by one or more neural networks that are trained through a machine learning training technique, e.g., a reinforcement learning training technique.

The agent identification system can receive a request to identify one or more agents in a target system and to characterize which variables of the target system represent agent decisions within the target system. In particular, the agent identification system can build a causal model of the target system to predict incentivized behavior without prior knowledge of the internal workings of the target system.

Additionally, the techniques described enable the processing of raw empirical data to generate a causal graph specifying decisions and utilities as nodes for the identified agent within the target system. More specifically, in some cases, a causal graph can be generated from a set of experiments that involve perturbing the system using interventions to modify variable elements of the system and agents can be discovered in an automated way from the system's response to these interventions. (A causal graph can refer to a graph of nodes and edges, where an edge connects a first node to a second node if an entity represented by the first node has a causal influence on an entity represented by the second node).

Further, the techniques described provide the flexibility to translate between causal graphs as described above and game-theoretic causal games or intervention diagrams, which can facilitate agent discovery through identifying which variables represent agent decisions and which represent the objectives those decisions optimize.

The subject matter described in this specification can be implemented in particular embodiments so as to realize one or more of the following advantages.

The agent identification system described in this specification can process data from a target system to build a causal model of the target system through a fully automated process that can identify decision and utility nodes in a causal graph. Furthermore the system can discover agents by running a large number of interventions on the target system.

The agent identification system can also build causal models and identify agents in complex systems well beyond what could be analyzed by a human or solely in the human mind. In particular, the techniques streamline agent discovery in situations where experimentation is cheap, such as in software simulations. Additionally, the techniques can be implemented to discover agents in software systems with thousands of components implemented across millions of lines of computer code or electrical systems spanning entire electrical grids.

Notably, identifying agents in systems can facilitate analysis and modifications of system designs, e.g., through automated processes, to improve system safety and robustness.

Implementations of the system can be grounded in real-world or simulated causal experiments. In particular, the agent identification system can generate the correct causal model and promote the trust and assurance that it can be used for the purpose of system design by following the same methods to generate the correct causal model across varied target systems.

In some implementations, the target system is a software system, e.g., that includes a collection of software modules, where each software module implements operations defined by a set of computer code. The software system can be, e.g., a software system configured to control operations in a facility (e.g., a data center or a manufacturing facility), a software system configured to control operations of an autonomous or semi-autonomous physical, e.g. mechanical, entity (e.g., a robot, a vehicle, or an aircraft), a software system configured to control operations in a user device (e.g., a smartphone or smartwatch), operating system software for managing hardware and software resources in a computer system, a software system for controlling operations of a medical device (e.g., an implanted medical device, e.g., a pacemaker, or a drug delivery system), or a software system for controlling a distributed sensor network (e.g., a sensor network for monitoring atmospheric signals, oceanic signals, etc.).

In some cases, software systems can include machine learning software modules, e.g., that implement machine learning operations. In particular, the machine learning operations can include adjusting a set of parameter values of a machine leaning model to optimize an objective function, e.g., that measures a performance of the machine learning model on a machine learning task. The optimization target may represent a measure of utility, as represented by a utility element (described later), that is to be maximized.

Variable elements in software systems can include any appropriate elements of the software system. For instance, in a model of a software system, object-level nodes can represent variable elements such as outputs generated by various software modules in the software system, or operational parameters of the software system (e.g., power consumption of hardware implementing the operations of the software system). An output generated by a software module in a software system can include, e.g., one or more ordered collections of numerical values (e.g., vectors, matrices, or other tensors of numerical values), or one or more software instructions (e.g., represented in any appropriate computer code format, e.g., in binary format) to be provided to other software modules in the software system. As another example, in a model of a software system, mechanism nodes can represent variable elements such as the computer code that defines the operations implemented by each of the software modules. Thus, a given software module in a software system can have an associated object-level node, e.g., representing outputs generated by the software module, and an associated mechanism node, e.g., representing the computer code defining the operations implemented by the software module.

The agent identification system can cause any appropriate interventions to be applied to the variable elements of a software system. For instance, the agent identification system can apply an intervention that modifies an output of a software module, e.g., by setting the output of the software module to be a predefined output, e.g., from an appropriate set of predefined outputs. As another example, the agent identification system can apply an intervention that modifies computer code that defines the operations implemented by a software module.

An agent in a software system can refer to a part of the software system (e.g., one or more modules in the software system), e.g., that performs actions which are selected in accordance with an action selection policy that is conditioned on the state of the software system. An agent in a software system can perform actions directed to optimizing a variable element of the software system referred to as a “utility” element. The agent identification system can automatically identify utility elements being optimized by agents in a software system. Utility elements in a software system can include, e.g., operational parameters of the software system, e.g., power consumption by hardware implementing the software system, or latency in executing certain tasks (e.g., retrieving data elements from a memory). As an example in a machine learning system, e.g. a reinforcement learning system, a utility element may represent a reward, or expected reward or return, received by the agent when performing a task.

Agents can represent critical parts of software systems, e.g., that direct and control key aspects of the overall behavior of the software system. After the agent identification system identifies an agent in a software system, computer code implementing the agent can be analyzed and tested (e.g., through manual or automated processes) to determine the robustness and stability of operations implemented by the computer code. The utility element being optimized by the agent can be assessed (e.g., through manual or automated processes) to identify possible failure modes or safety issues arising from goal-directed behavior implemented by the agent to optimize the utility element.

The agent identification system thus provides an automated approach for identifying agents in a software system, e.g., as part of a process for improving the safety and robustness of the software system. The agent identification system can generate a model of a software system even if the source code for the software system is unavailable, e.g., by processing binary code defining the operation of the software system. The agent identification system can thus enable binary static analysis of software systems.

In some implementations, the target system is a real-world system or a computer-implemented simulation of a real-world system, e.g., an electrical system. Electrical systems can include networks of electrical components, e.g., microchips, field programmable gate arrays (FPGAs), semiconductors, vacuum tubes, discharge devices, power sources, resistors, capacitors, antennas, and the like. Electrical systems can be implemented across various scales, e.g., on single microchips, on printed circuit boards (PCBs), or across electrical grids.

Variable elements in electrical systems can include any appropriate elements of the electrical system. For instance, in a model of an electrical system, object-level nodes can represent variable elements such as electrical properties (e.g., voltage, current, resistance, etc.) measured at various locations in the electrical system, e.g., at the outputs of various components in the electrical system. As another example, in a model of an electrical system, mechanism nodes can represent variable elements such as the configuration of components in the electrical system.

The agent identification system can cause any appropriate interventions to be applied to the variable elements in a simulation of an electrical system. For instance, the agent identification system can apply an intervention that modifies the electrical properties at a location in the simulation of the electrical system, e.g., by setting the current in a wire at the location to a defined value. As another example, the agent identification system can apply an intervention that modifies the wiring in a component of the simulation of the electrical system.

An agent in an electrical system can refer to a part of the electrical system (e.g., a component in the electrical system, e.g., a chip in the electrical system), e.g., that performs actions which are selected in accordance with an action selection policy that is conditioned on the state of the electrical system. An agent in an electrical system can perform actions directed to optimizing a utility element in the electrical system. The agent identification engine can automatically identify utility elements in an electrical system that are optimized by agents in the electrical system. Utility elements in an electrical system can include, e.g., operational parameters of the electrical system, e.g., maximum load on the electrical system, voltage stability across the electrical system, and the like.

Agents can represent critical parts of electrical systems, e.g., that direct and control key aspects of the overall behavior of the electrical system. After the agent identification system identifies an agent in a simulation of an electrical system, components of the electrical system implementing the agent can be analyzed and tested to assess their robustness and stability, e.g., in extreme or unusual operating conditions. A utility element being optimized by an agent can be assessed to (e.g., through manual or automated processes) to identify possible failure modes or safety issues arising from goal-directed behavior implemented by the agent to optimize the utility element in the electrical system.

The agent identification system thus provides an automated approach for leveraging a simulation of an electrical system to identify agents in the electrical system, e.g., as part of a process for improving the safety and robustness of the electrical system.

There is also described a computer-implemented method of designing, and then optionally constructing, a machine learning system, such as a reinforcement learning system, that learns an action selection policy for controlling an agent to interact with an environment to perform a task. In general “constructing” such a system can involve implementing the system on one or more computers, using one or more storage devices coupled to the computer(s) and storing instructions that, when executed, cause the computer(s) to perform operations to implement the system. In general there may be one or more agents each configured to perform one or more tasks. The machine learning system may be configured to, at each of a plurality of time steps, receive a current observation characterizing a state of the environment at the time step, and process the current observation to select an action to be performed by the agent in response to the current observation using the action control policy.

The method can include determining a first design for the machine learning system and implementing, e.g., constructing and using, the first design, in the real-world or in simulation, to control the agent to interact with the environment to perform the task. A method as described above may be used to process a request to identify one or more agents in the environment and hence to generate the data defining a model of a system that includes the agent and the environment, including the set of nodes and the set of edges, and e.g., to obtain the data that identifies the one or more agents in the system. In implementations the set of nodes and the set of edges defines a causal graph. In implementations the current observation determines values for one or more of the variable elements, e.g., for one or more object-level nodes.

The method uses one or both of the causal graph and the data that identifies the one or more agents in the system to identify one or more causal relationships between the observations processed by the machine learning system and the actions selected by the machine learning system. The first design of the machine learning system may then be modified (manually or automatically) dependent on the identified causal relationships to obtain an updated design of the machine learning system. For example the architecture of the machine learning system may be altered, and/or the machine learning system may be configured to process a different observation (e.g. the observation characterizing the state of the environment may be changed to obtain values for a different set of variables characterizing the state of the environment), and/or the machine learning system may be configured to select a different set of (continuous or discrete) actions for performing the task. The design of the machine learning system may then be modified randomly or according to a design principle, e.g., to avoid a causal link between a particular observation or distribution of observations and a particular action or distribution of actions. The design modification and agent identification/system analysis steps may be repeated to iteratively refine the design to obtain the updated design. The method may further comprise constructing a machine learning system according to the updated design. The constructed machine learning system may then be used (after training) to select actions in the environment to perform the task.

Some implementations of the method can be used to improve the fairness, safety, robustness or stability of a machine learning system. For example to improve fairness an implementation of the method may be used to remove the dependence of a selected action on a particular observation (variable) where dependence on the observation (variable) might otherwise result in undesired bias in the selected actions. To improve safety an implementation of the method may be used to remove the dependence of a selected action on a particular observation (variable) where dependence on the observation (variable) might otherwise result in unsafe behavior of the agent, e.g., of a mechanical agent such as a robot or (semi) autonomous vehicle. To improve robustness or increase stability an implementation of the method may be used to reduce the dependence of a selected action on perturbations in an observation. As a further example an implementation of the method may be used to reduce the training or improve the performance of the machine learning system when in a new environment in the real-world, e.g., by selecting particular observations (variables) on which a selected action depends so that these correspond to factors of variation in the real-world.

In implementations of the method the machine learning system is used in controlling the agent in a real-world environment, and is configured to process an observation relating to a state of the real-world environment to generate select an action that relates to an action to be performed by the agent in the real-world environment. As some examples the agent may be i) a mechanical agent used in the real-world environment to perform a task, or ii) an electronic agent configured to control a manufacturing unit in a real-world manufacturing environment, or iii) an electronic agent configured to control operation of items of equipment in the real-world environment of a service facility comprising a plurality of items of electronic equipment, or iv) an electronic agent used in the real-world environment of a power generation facility and configured to control the generation of electrical power by the facility or the coupling of generated electrical power into the grid. Such an electronic agent may be implemented n hardware, software configured to control a processor, or a combination of both these. Thus a software system or electrical system, e.g. as described above, may be used as (or instead of) the machine learning system that learns an action selection policy. Thus, for example, the method may be used for designing, and optionally constructing, a software system configured to control operations in a user device or medical device.

According to one aspect, there is provided a method performed by one or more computers, the method comprising: receiving a request to identify one or more agents in a system, wherein each agent is an entity that interacts with the system by performing actions that are selected in accordance with an action selection policy; and in response to the receiving the request: generating data defining a model of the system, comprising: generating data defining a set of nodes, wherein each node represents a respective variable element of the system; and generating data defining a set of edges, wherein each edge represents a relationship between a respective pair of variable elements of the system, and wherein generating the set of edges comprises: transmitting instructions to cause a plurality of interventions to be applied to the system, wherein each intervention modifies one or more variable elements in the system; and obtaining response data that defines a respective response of the system to each of the plurality of interventions that are applied to the system; and processing the response data to generate the set of edges; and processing the model of the system to identify one or more of the variable elements in the system as being decision elements, wherein each decision element represents an action selected by a respective agent in the system; identifying one or more agents in the system based on the decision elements; and outputting data that identifies the agents in the system.

In some implementations, the plurality of interventions comprise a set of interventions corresponding to a pair of nodes comprising a first node and a second node; and processing the response data to generate the set of edges comprises determining whether the pair of nodes is connected by an edge based on the response data for set of interventions corresponding to the pair of nodes.

In some implementations, the set of interventions corresponding to the pair of nodes comprising the first node and the second node comprises a plurality of interventions that differ only in the modification applied to the variable element represented by the first node.

In some implementations, determining whether the pair of nodes is connected by an edge based on the response data for the set of interventions corresponding to the pair of nodes comprises: determining that a response of the second node is not constant over the set of interventions corresponding to the pair of nodes; and in response, determining that an edge connects the first node to the second node.

In some implementations, the set of nodes comprises: (i) a plurality of nodes designated as object-level nodes, and (ii) a plurality of nodes designated as first mechanism nodes, wherein each first mechanism node corresponds to a respective object-level node and represents a model for a behavior of the variable element represented by the object-level node.

In some implementations, processing the model of the system to identify one or more of the variable elements in the system as being decision elements comprises, for one or more object-level nodes: determining that the mechanism node corresponding to the object-level node receives an incoming edge from a different mechanism node; and in response, identifying the variable element represented by the object-level node as being a decision element.

In some implementations, the set of nodes further comprises: (iii) a plurality of nodes designated as second mechanism nodes, wherein each second mechanism node corresponds to a decision rule node representing the action selection policy of one of the agents, and one or more of the second mechanism nodes receives an incoming edge from one or more of the first mechanism nodes.

In some implementations, the method further comprises modifying at least one variable element represented by an object-level node with one of the interventions.

In some implementations, the method further comprises processing the model of the system to identify one or more of the variable elements in the system as being utility elements, wherein each utility element represents an element that is an optimization target for one or more agents in the system.

In some implementations, processing the model of the system to identify one or more of the variable elements in the system as being utility elements comprises: identifying each of one or more edges in the set of edges as being terminal edges; and for each of one or more object-level nodes: determining that the model of the system includes an outgoing terminal edge from the mechanism node for the object-level node to the mechanism node for a different object-level node that represents a decision element; and in response, identifying the variable element represented by the object-level node as being a utility element.

In some implementations, identifying each of one or more edges in the set of edges as being terminal edges comprises, for each edge that is identified as being a terminal edge: determining that the edge connects a first mechanism node to a second mechanism node; and transmitting instructions to cause a plurality of interventions to be applied to the system, wherein each of the plurality of interventions differ only in the modification applied to the variable element represented by the object-level node corresponding to the second mechanism node.

In some implementations, the method further comprises, for each decision element in the system, identifying a corresponding utility element that is an optimization target for the decision element.

In some implementations, for each decision element, identifying the corresponding utility element that is an optimization target for the decision element comprises identifying, as the corresponding utility element, an element that is represented by an object-level node having a corresponding mechanism node that is connected to the mechanism node for the decision element by a terminal edge.

In some implementations, identifying one or more agents in the system based on the decision elements comprises determining that the system includes a respective agent corresponding to each decision element, wherein the agent corresponding to a decision element selects the action represented by the decision element.

In some implementations, for each of the plurality of interventions that are applied to the system, obtaining response data that defines a respective response of the system to the intervention comprises obtaining a respective value of each variable element of the system after the system is modified in accordance with the intervention applied to the system.

In some implementations, the system is a computer-implemented simulation of a real-world system.

In some implementations, the real-world system comprises an electrical system.

In some implementations, the variable elements of the electrical system comprise elements defining electrical properties at various locations in the electrical system.

In some implementations, the electrical properties comprise one or more of: voltage, current, or resistance.

In some implementations, the system is a software system.

In some implementations, the software system comprises one or more machine learning software modules.

In some implementations, the variable elements of the system comprise elements defining values of outputs of software modules of the software system.

According to another aspect, there is provided a computer-implemented method of constructing a machine learning system that learns an action selection policy for controlling an agent to interact with an environment to perform a task, wherein the machine learning system is configured to, at each of a plurality of time steps: receive a current observation characterizing a state of the environment at the time step, and process the current observation to select an action to be performed by the agent in response to the current observation using the action control policy; the method comprising: determining a first design for the machine learning system; implementing the first design of the machine learning system to control the agent to interact with the environment to perform the task; using the method described herein to process a request to identify one or more agents in the environment to generate the data defining a model of a system that includes the agent and the environment, including the set of nodes and the set of edges, and to obtain the data that identifies the one or more agents in the system, wherein the set of nodes and the set of edges defines a causal graph, and wherein the current observation determines values for one or more of the variable elements; using one or both of the causal graph and the data that identifies the one or more agents in the system to identify one or more causal relationships between the observations processed by the machine learning system and the actions selected by the machine learning system; modifying the first design of the machine learning system dependent on the identified causal relationships to obtain an updated design of the machine learning system; and constructing a machine learning system according to the updated design.

In some implementations, the machine learning system is used in controlling the agent in a real-world environment, and is configured to process an observation relating to a state of the real-world environment to generate select an action that relates to an action to be performed by the agent in the real-world environment.

In some implementations, either i) the agent is a mechanical agent used in the real-world environment to perform a task, or ii) the agent is an electronic agent configured to control a manufacturing unit in a real-world manufacturing environment, or iii) the agent is an electronic agent configured to control operation of items of equipment in the real-world environment of a service facility comprising a plurality of items of electronic equipment, or iv) the agent is an electronic agent used in the real-world environment of a power generation facility and configured to control the generation of electrical power by the facility or the coupling of generated electrical power into the grid.

According to another aspect, there is provided a system comprising: one or more computers; and one or more storage devices communicatively coupled to the one or more computers, wherein the one or more storage devices store instructions that, when executed by the one or more computers, cause the one or more computers to perform operations of the methods described herein.

According to another aspect, there are provided one or more non-transitory computer storage media storing instructions that when executed by one or more computers cause the one or more computers to perform operations of the methods described herein.

The details of one or more embodiments of the subject matter of this specification are set forth in the accompanying drawings and the description below. Other features, aspects, and advantages of the subject matter will become apparent from the description, the drawings, and the claims.

### DESCRIPTION OF FIGURES

FIG. 1 depicts an example agent identification system.

FIG. 2 depicts a simplified target system and illustrates construction of a causal model and a causal game from the target system.

FIG. 3A is a flow diagram of an example process for identifying one or more agents in a target system.

FIG. 3B is a flow diagram of an example process for generating a model of the target system, e.g., as a causal graph.

FIG. 3C is a flow diagram of an example process for generating the set of edges for the model of the target system.

FIG. 3D is a flow diagram of an example process for identifying one or more variable elements of the target system as being utility elements.

FIG. 4 provides an example of an action selection system used in target system applications involving reinforcement learning.

FIG. 5 demonstrates the output of an agent identification system for a modified action Markov Decision Process (MDP).

FIG. 6 demonstrates the output of an agent identification system for an actor-critic reinforcement learning method.

FIG. 7 is a flow diagram of an example process for constructing a machine learning system that learns an action selection policy for controlling an agent to interact with an environment to perform a task.

Like reference numbers and designations in the various drawings indicate like elements.

### DETAILED DESCRIPTION

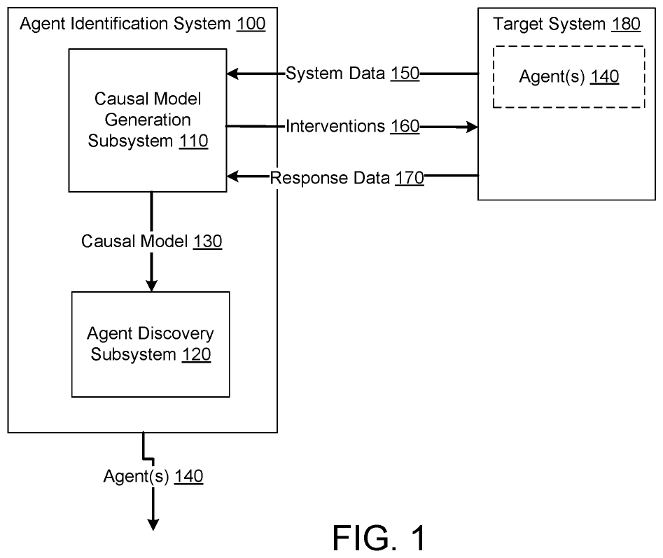

FIG. 1 depicts an example agent identification system 100 that is configured to discover (identify) one or more agents 140 present in a target system 180. The agent identification system 100 is an example of a system implemented as computer programs on one or more computers in one or more locations in which the systems, components, and techniques described below are implemented.

In particular, the agent identification system 100 can include: (i) a causal model generation subsystem 110 that can process data from the target system 180 to generate a causal model 130, and (ii) an agent discovery subsystem 120 that can use the causal model 130 to identify the presence of one or more agents 140 within the target system 180.

In this specification, a causal model 130 is a representation of the causal relationships within a system. As an example, the model of the target system 180 can be a causal graph. In particular, the causal model generation subsystem 110 can generate data that defines a set of nodes that represent the variable elements of the system and a set of edges that each represent a relationship between a respective pair of variable elements of the target system 180. For instance, the model of the target system 180 can include an edge connecting a first node to a second node if a change in the variable element represented by the first node can induce a change in the variable element represented by the second node in the target system 180. Thus, the graph can represent causal relationships between variable elements in the target system.

More specifically, the causal model generation subsystem 110 can process system data 150 to characterize the variable elements of the target system 180 as nodes (e.g., in the causal model 130). Then, the causal model generation subsystem 120 can generate one or more interventions to run on the target system 180 to create the edges (e.g., in the causal model 130).

To generate the set of edges, the causal model generation subsystem 110 can transmit instructions to cause one or more interventions 160 to be applied to the target system 180, where each intervention 160 modifies one or more variable elements in the target system 180.

For example, an intervention 160 can change the value of a variable element or can modify the variable element by holding the variable element constant.

In particular, an intervention 160 can target all the nodes or a subset of the nodes in the causal model 130. The causal model generation subsystem 110 can obtain response data 170 that defines a respective response of the target system 180 to each of the interventions 160 that are applied to the target system 180. The causal model generation subsystem 110 can then process the response data 170 to generate the set of edges in the model of the target system 180.

The agent discovery subsystem 120 can process the model of the target system 180 to identify one or more of the variable elements in the target system 180 as being decision elements, where each decision element represents an action selected by a respective agent 140 in the target system. The agent identification system 100 can then identify one or more agents 140 in the target system 180 based on the decision elements, and output data that identifies the agents 140 in the target system 180.

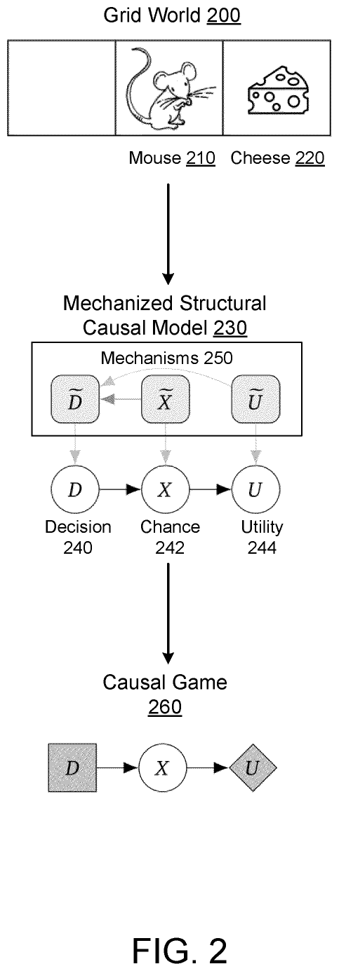

FIG. 2 shows a toy target system for the purpose of conveniently illustrating certain aspects of the methods described in this specification with reference to a simple example. In this example, a mouse 210 aims to reach a piece of cheese 220 in a simple one-dimensional three-square grid world 200. In this simplified example, the mouse 210 is clearly an agent, e.g., because the mouse 210 is moved by reasons to make decisions that help it reach the cheese 220. However, if it is assumed that the presence of one or more agent(s) is unknown in the target system, the agent identification system can interact with this simplified target system to construct a causal model of the target system that can identify the mouse as an agent within the target system.

The mouse 210 starts in the middle square in this target system. The mouse 210 can go either left or right, a binary decision variable 240 represented. There is also some ice in the grid-world 200 that can cause the mouse 210 to slip, which introduces some randomness to the target system. More specifically, the mouse's position, X, follows its decision, D, with probability p=0.75, and slips on the ice in the opposite direction with probability 1−p. Since the position is left up to chance after the decision (due to the ice), X can be considered a chance variable 242. Additionally, the cheese 220 can be in the right square with probability q=0.9, and the left square with probability 1−q. The mouse gets a reward or utility 244, U, of 1 for getting the cheese 220, and 0 otherwise.

The agent identification system can represent the decision problem as a causal model. As an example, the system can process data from the mouse in the grid-world target system and generate a structural causal model that parametrizes the deterministic structural elements of the target system as endogenous variables, such as the decision 240, chance 242, and utility 244 variables, of the system. More specifically, deterministic structural equations can relate the endogenous variables to each other and to exogeneous variables, like p and q, which introduce randomness in the target system.

In some examples, the mouse's decision problem can be represented by a mechanized structural causal graph model 230, which is a variant of structural causal graph models that include mechanism 250 variable nodes that relate to respective object-level nodes.

Mechanisms 250 can represent a model for a behavior of the variable element (e.g., decision 240, chance 242, and utility 244 variables) represented by the object-level node.

In particular, a mechanism 250 parameterizes how the object-level node depend on their object-level “parent” nodes, i.e. input nodes.

In some examples, the agent identification system can have two (or more) types of mechanism nodes. More specifically, mechanisms can be distinguished by whether or not they have incoming terminal edges, which will be described below.

As an example, a first type of mechanism node can be identified as not having incoming terminal edges. More specifically, this first type of mechanism can define a behavior of the variable element represented by the object-level node. In some implementations this is referred to as a first type of mechanism node or a parameter node, since it parametrizes some mechanism independent of agents.

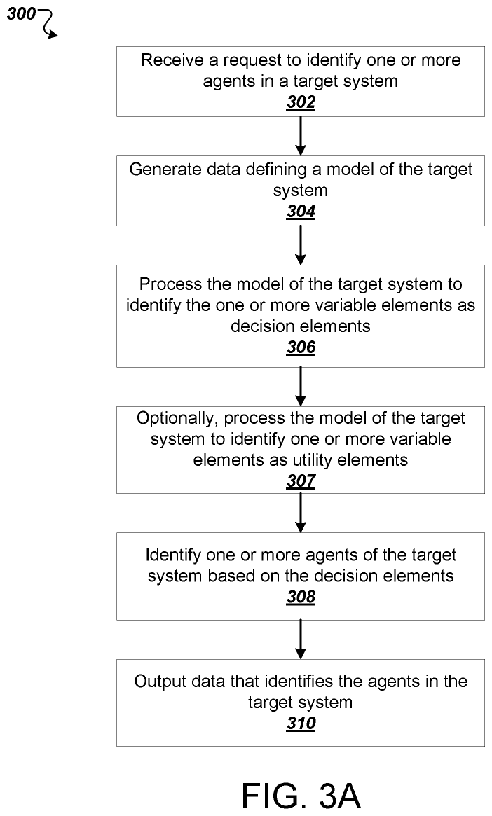

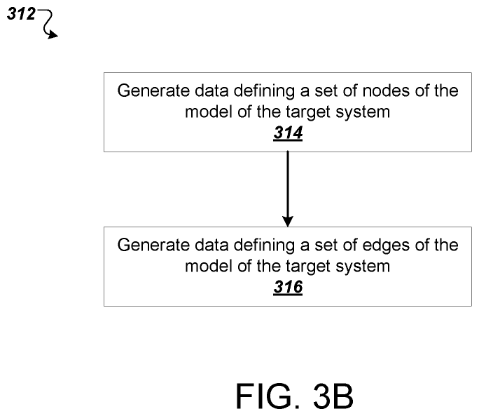

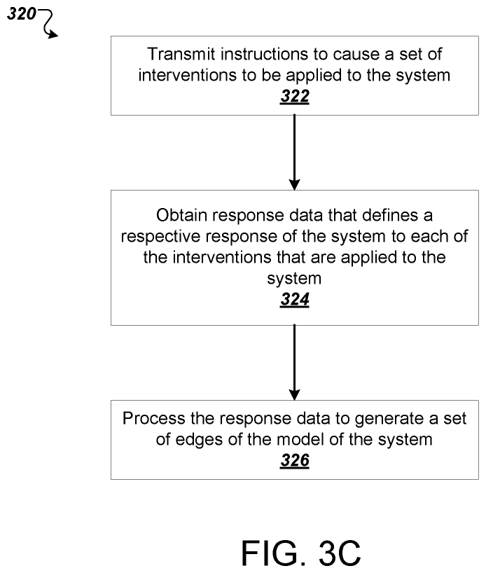

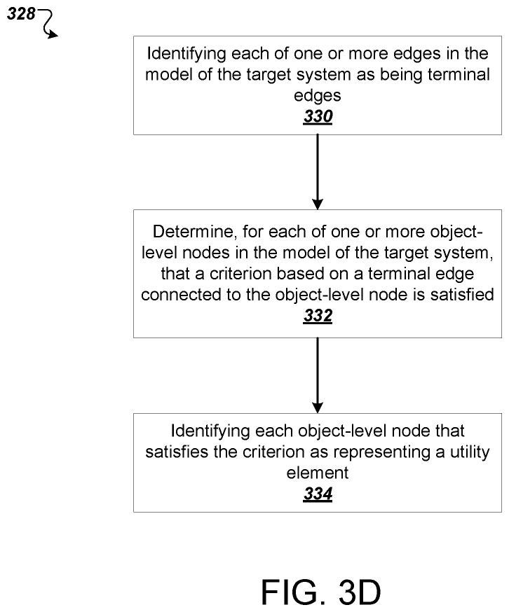

As another example, the agent identification system can have a first type of mechanism as described above, and a second type that can parametrize how mechanism-level variables depend on their mechanism-level parents. This second type of mechanism node can have incoming terminal edges. A terminal edge can be defined such that the child mechanism node responds to its parent mechanism node even after any effects on the children of the child mechanism node have been removed by means of interventions. In particular, this type of edge is a terminus and can be used to distinguish a utility node from the other node types, as will be covered in more detail in FIG. 3D.

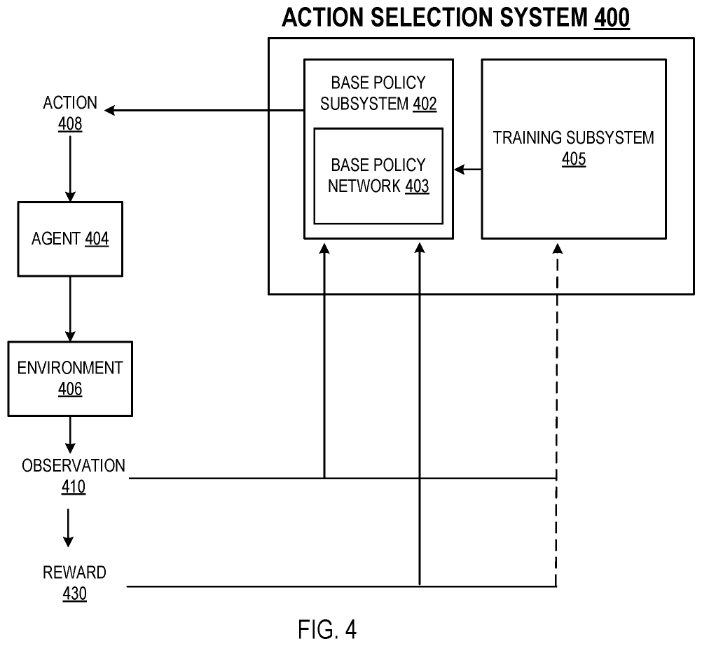

More specifically, this second type of mechanism can define a decision rule node representing the action selection policy of one of the agents. As an example, an agent can set a decision rule TD in accordance with an action selection policy for each of their decisions, where the action selection policy maps the information available at the time of a particular decision to an outcome of the decision. An example functioning of an action selection policy will be covered in more detail in FIG. 4.

In the case of both the first and second types of mechanism nodes being included in the mechanized structural causal graph model 230, the deterministic structural equations that define the parametrization of the mechanized causal graph can be of the form:

$$= {\{ V = {f}^{V} ( P {a}^{V} , {∈}^{V} ; \tilde{V} ) \}}_{V ∈ V} ⋃ {\{ \tilde{V} = {f}^{\tilde{V}} ( P {a}^{\tilde{V}} , {ϵ}^{\tilde{V}} ) \}}_{\tilde{V} ∈ \tilde{V}}$$

This equation specifies a set of one or more structural equations (f^{V}) for each of the object-level variables V, where each is governed by a structural function of its input “parent” Pa^{V} nodes, any input exogeneous (unobserved) variables ε^{V}, and each is separately conditioned on their own mechanism nodes \tilde{V}. In particular, for each V, \tilde{V} is parametrized by its own structural equation (f^{\tilde{V}}), which is defined as a function of its input “parent” nodes Pa^{\tilde{V}} and the exogeneous (unobserved) variables of the mechanisms ϵ^{\tilde{V}}.

The edges of the associated mechanized causal graph can be partitioned into different types of edges based on which type of nodes they connect. As an example, object edges can connect object nodes, function edges can connect mechanism nodes and object nodes, and mechanism edges can connect mechanism nodes.

More specifically, in the mouse example, the mechanized structural causal model 230 for the mouse depends on the values of p and q, which are exogeneous variables that determine the position of the ice and the cheese 220, respectively. The intuition that the mouse would choose a different behavior for other settings of the parameters p and q, can be captured by mechanism nodes 250: \tilde{D}, \tilde{X}, Ũ, representing the mouse's decision rule and its dependence on the values of p and q. The causal links between the mechanisms show that if the cheese location is changed, say from p=0.9 to q=0.1, and the mouse is aware of this, then the mouse's decision rule changes in accordance with the fact that it is now more likely to find the cheese in the leftmost spot.

In particular, changing these variables, changes the optimal decision 240: if p, q>0.5 or p, q<0.5, then D=1 is optimal, if p<0.5, q>0.5 or p>0.5,q<0.5 then D=0 is optimal, and if either p or q is 0.5, then both D=0 and D=1 are optimal.

An example method for generating a mechanized structural causal model 230 will be covered in FIG. 3A-3D. The generated causal model can then be used for agent identification.

In certain examples, a causal game 260 can be constructed from the mechanized structural causal model 230 for the purpose of agent identification. In particular, identifying decisions can be used to discover the presence of one or more agents in a target system. An example for identifying which variables represent agent decisions and which represent the objectives those decisions optimize (i.e., the reasons that move the agent) will be covered in greater detail in FIG. 3A-3D.

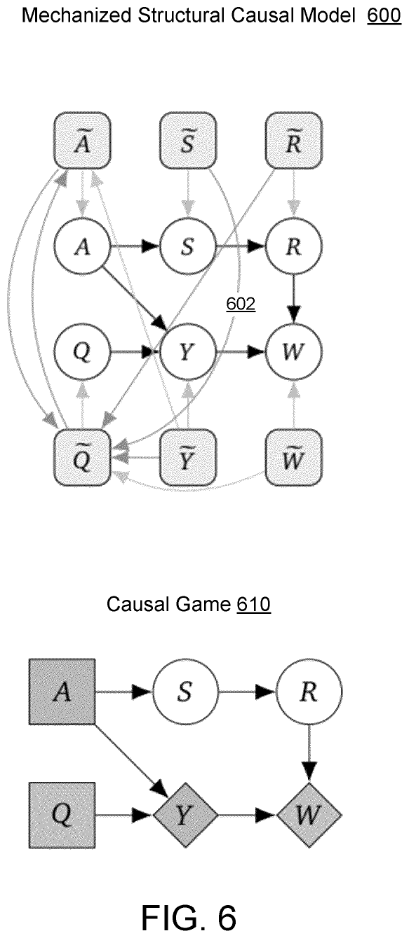

A causal game 260 parametrizes the target system in the same way as a structural causal model: the agent makes a decision, D, which affects its position, X, which affects its utility, U. These are object-level variables which can be represented by nodes. As an example, decisions can be represented by square nodes, chance variables by round nodes, and utilities by diamond nodes. An example case with multiple agents will be described in more detail in FIG. 6.

A causal game 260 can be further distinguished from a structural causal model since the decision variables have no structural equations specified, e.g., if there is an agent in the system, then the agent is free to choose outcomes without restrictions, given the information revealed by the outcome. In particular, edges connecting decision nodes represent what information is available to an agent when making the decision.

FIG. 3A is a flow diagram of an example process 300 for identifying one or more agents in a target system. An agent identification system, e.g., the agent identification system of FIG. 1, appropriately programmed in accordance with this specification, can perform the process 300.

The agent identification system receives a request to identify one or more agents in a target system (302). Each agent is an entity that interacts with the system by performing actions that are selected in accordance with an action selection policy. The agent identification system can receive the request from any appropriate source, e.g., from a user of the agent identification system, and by any channel, e.g., by way of an application programming interface (API) made available by the agent identification system.

In response to receiving the request, the agent identification system generates data defining a model of the target system (304). The model of the target system can be represented as a graph, e.g., a causal graph, that includes a set of nodes and a set of edges. Each node can represent a variable element of the system, e.g., a decision, chance, mechanism, or utility variable element. Each edge can connect a respective pair of nodes and can represent a relationship between a respective pair of variable elements of the system.

In some implementations, the set of nodes of the model of the target system includes: (i) a set of nodes designated as object-level nodes, and (ii) a set of nodes designated as first mechanism nodes. As discussed in FIG. 2, each first mechanism node corresponds to a respective object-level node and represents a model for a behavior of the variable element represented by the object-level node.

In some implementations, the set of nodes of the model of the target system further includes a set of nodes designated as second mechanism nodes. More specifically, each second mechanism node corresponds to a decision rule node representing the action selection policy of an agent in the target system. As discussed in FIG. 2, one or more of the mechanism nodes can receive an incoming edge from one or more of the second mechanism nodes.

An example process for generating a model of the target system is described in more detail with reference to FIG. 3A.

The agent identification system processes the model of the target system to identify any decision elements; in particular, the agent identification system can, in some cases, identify one or more of the variable elements in the target system as decision elements (step 306). In some implementations, identifying the decision elements includes, for one or more object-level nodes, determining that the mechanism node corresponding to the object-level node receives an incoming terminal edge from a different mechanism node. In response, the agent identification system identifies the variable element represented by the object-level node as being a decision element.

In combination with identifying decision and utility elements, the agent identification system can identify any of the variable elements in the target system as being utility elements (307). Each utility element represents an element of the target system that is an optimization target for one or more of the agents in the target system. An example process for identifying utility elements in the model of the target system is described in more detail with reference to FIG. 3D.

The agent identification system identifies one or more agents in the target system based on the decision and utility elements (308). Each decision element represents an action selected by a respective agent in the system.

For instance, the agent identification system can determine that the target system includes a respective agent corresponding to each decision element, where the agent corresponding to a decision element selects the action represented by the decision element.

As another example, Algorithm 3 (shown below) provides a method for converting a mechanized causal graph into a game graph that can be used for agent identification:

Algorithm 3 Agency Identification. Converts
an mechanised causal graph to a game graph

Input: An mechanised causal graph [symbol] = ( [symbol] , E),
with nodes [symbol] = V∪\tilde{V} and edges E = E^{obj}∪E^{func}∪E^{mech},

| | with E^{term} ⊆ E^{mech}. | |
|---|---|---|
| 1: | D ← Ø | |
| 2: | U ← Ø | |
| 3: | for \tilde{V} ∈ \tilde{V} | [symbol] Decision identification |
| 4: | if ∃\tilde{W} ∈ \tilde{V} \ | |
| | {\tilde{V}} such that (\tilde{W}, | |
| | \tilde{V}) ∈ E^{mech} | |
| 5: | D ← D ∪ {V} | |
| 6: | for D ∈ D | [symbol] Utility identification |

| | |
|---|---|
| 7: | for V ∈ V \ {D} |
| 8: | if (\tilde{V}, \tilde{D}) ∈ E^{term} |
| 9: | U ← U ∪ {V} |
| 10: | if D is coloured |
| 11: | Colour(V) ← Colour(D) |
| 12: | else if V is coloured |
| 13: | Colour(D) ← Colour(V) |
| 14: | else |
| 15: | Colour(D) ← NewColour |
| 16: | Colour(V) ← Colour(D) |
| 17: | X ← V \ {U ∪ D} |

Output: game graph [symbol] = (N, V, E), where V = X ∪ U ∪ D and E = E^{obj}.

where decision nodes are identified as nodes whose mechanisms have incoming edges, while utility nodes are identified by having an outgoing terminal edge from its associated mechanism variable. The targets of the edge can indicates which decision nodes optimize it. In this example, the coloring scheme defines a one color per agent color scheme such that the decisions that share the same utility come from the same agent.

In an example that applies Algorithm 3 to a mechanized structural causal model in order to identify the one or more agents, the agent identification system will identify any decision node D under the following conditions: a utility node U, or a chance node X on a directed path from D to U, is included in the set of nodes V. Additionally, the utility/mediator node must be sufficiently important to the agent controlling D that its mechanism shapes the agents behavior, and mechanism interventions are available that change the agent's optimal policy for controlling U (or X).

The agent identification system outputs data that identifies the agents in the target system (310). Optionally, the agent identification system can also output, for each agent in the target system, data identifying the utility element that defines the optimization target for the agent. The agent identification system can output the described data, e.g., by storing the data in a memory, or by transmitting the data over a data communications network.

FIG. 3B is a flow diagram of an example process 312 for generating a model of the target system, e.g., as a causal graph. An agent identification system, e.g., the agent identification system of FIG. 1, appropriately programmed in accordance with this specification, can perform the process 312.

The agent identification system generates data defining a set of nodes, where each node represents a respective variable element of the target system (314). The agent identification system can identify the nodes in a software system by automatically parsing source code for the software system in accordance with a set of predefined rules, e.g., such that some or all of the data variables, modules, objects, etc., defined by the source code are represented by respective nodes. The agent identification system can identifies the nodes in an electrical system, e.g., by parsing one or more circuit diagrams representing the electrical system in accordance with a set of predefined rules.

The agent identification system generates data defining a set of edges (316). Each edge represents a relationship between a respective pair of variable elements of the target system. An example process for generating the set of edges is described in more detail with reference to FIG. 3C.

The model of the target system can include the set of nodes (generated in step 314) and the set of edges (generated in step 316). In some implementations, the model of the target system is a causal graph.

FIG. 3C is a flow diagram of an example process 320 for generating the set of edges for the model of the target system. An agent identification system, e.g., the agent identification system of FIG. 1, appropriately programmed in accordance with this specification, can perform the process 320.

The agent identification system transmits instructions to cause a set of interventions to be applied to the target system (322). Each intervention modifies one or more variable elements of the target system. The agent identification system can transmit the instructions, e.g., by way of a data communications network.

The agent identification system obtains response data that defines a respective response of the target system to each of the interventions that are applied to the target system (324). The agent identification system can measure the response data in any appropriate manner. For instance, if the target system is a software system, then the agent identification system can measure the response data, e.g., by measuring the values of certain data variables generated by the software system. As another example, if the target system is a physical system, e.g., an electrical system, then the agent identification system can measure the response data by way of one or more sensors, e.g., voltage sensors, current sensors, resistance sensors, etc.

The agent identification system processes the response data to generate the set of edges (326). In some implementations, for a pair of nodes that includes a first node and a second node, the set of interventions can include interventions that differ only in the modification applied to the variable element represented by the first node. The agent identification system can determine whether the pair of nodes is connected by an edge based on the response data for the set of interventions. For instance, the agent identification system can determine that a response of the second node is not constant over the set of interventions corresponding to the pair of nodes, and in response, the agent identification system can determine that an edge connects the first node to the second node.

The agent identification system can apply any appropriate interventions to the target system. For instance, the agent identification system can apply an intervention that includes changing the value of a variable element or modifying a variable element by holding the variable element constant. The interventions can be made either before or after decision rules are selected, and can include both object-level interventions and mechanism-level interventions.

In the case of the agent identification system generating a mechanized structural causal model with object-level and mechanism nodes, three types of interventions can be defined: an object intervention on an object-level variable that changes or modifies the value of the variable without changing its mechanisms (if any), a mechanism intervention on a first mechanism node that removes the conditional independence of an object-level node on its parent nodes, and a mechanism intervention on a second mechanism that removes the conditional independence of a mechanism-level node on its parent nodes.

After each intervention, a respective value of each variable element of the target system after the target system is modified in accordance with the intervention can be obtained. In certain examples, the response data from the object-level interventions can then be processed with an algorithm to generate the set of edges for the object-level causal graph. A particular example algorithm for discovery of relationship edges between object-level variables is shown next:

Algorithm 1 Leave-one-out causal discovery

| Input: Interventional distributions {V_{y}} over variables V | |
|---|---|
| 1: | E ← Ø |
| 2: | for V ∈ V |
| 3: | for W ∈ V \ {V} |
| 4: | Y ← V \ {V} |
| 5: | for hard interventions do(Y = a), do(Y = b) differing |
| | only in the value they set for W |
| 6: | if Vₐ ≠ V_{b} |
| 7: | E ← E ∪ (W,V) |
| 8: | break |

Output: (V, E)

where the interventional distributions over variables V_{y} are realized as replacing a subset of the structural equations that form the mechanized causal graph containing nodes V and edges E, i.e. applying the interventional changes to the nodes do(Y=a, b, . . . ), generates an interventional distribution.

As another example, the above algorithm for leave-one-out causal discovery can be applied and then the correct set of edges defined for a mechanized structural causal model including mechanisms can be generated using the algorithm shown next:

Algorithm 2 Edge-labeled mechanised SCM discovery

Input: Interventional distributions { [symbol] _{y}} over variables [symbol] = V ∪ \tilde{V}

| | |
|---|---|
| 1: | ( [symbol] , E) ← leave-one-out-causal-discovery( [symbol] _{y}) |
| 2: | E^{obj} ← {(V, W) ∈ E : V, W ∈ V} |
| 3: | E^{mech} ← {(V, W) ∈ E : V, W ∈ \tilde{V}} |
| 4: | E^{func} ← {(V, W) ∈ E : V = \tilde{W}} |
| 5: | if E ≠ E^{obj} ∪ E^{mech} ∪ E^{func} : |
| 6: | Error: graph is not a mechanised SCM |
| 7: | E^{term} ← Ø |
| 8: | for (\tilde{V}, \tilde{W}) ∈ E^{mech} |
| 9: | for hard interventions do(Y = a), do(Y = b) applying structural interventions to each Y ∈ Ch^{V} |
| | and differing only in the value they set for W |
| 10: | if Vₐ ≠ V_{b} |
| 11: | E^{term} ← E^{term} ∪ (\tilde{V}, \tilde{W}) |
| 12: | break |

Output: (V ∪ \tilde{V}, E^{obj} ∪ E^{mech} ∪ E^{func}, E^{term})

where E^{obj} refers to edges between object nodes, E^{mech} refers to edges between mechanism nodes, E^{func} refers to an edge between object and mechanism nodes, and Ch^{V} correspond to the output “child” nodes.

In particular, the algorithm for edge-labeled mechanized structural causal model discovery can be applied to the mouse of FIG. 2 to define and apply interventions on the target system, obtain the interventional data from the target system, and generate a structural causal model.

For example, an intervention can be defined on X and U such that p, q>0.5, so that the optimal policy is D=1. Then, the intervention on X and U can be changed such that p, q<0.5, which reveals a change in the optimal policy to D=0. This specifies drawing an edge (\tilde{X}, \tilde{D}). By a similar argument, it will also draw an edge (Ũ, \tilde{D}), which will be a terminal edge. Thus, the algorithm for edge-labeled mechanized structural causal model discovery can produce the edge-labeled mechanized structural causal model 230.

FIG. 3D is a flow diagram of an example process 328 for identifying one or more variable elements of the target system as being utility elements. An agent identification system, e.g., the agent identification system of FIG. 1, appropriately programmed in accordance with this specification, can perform the process 328.

The agent identification system identifies each of one or more edges in the model of the target system as being terminal edges (330). More specifically, the system can identify terminal edges following lines 7-12 of Algorithm 2. In particular, each terminal edge connects a first mechanism node to a second mechanism node. To determine whether an edge that connects a first mechanism node to a second mechanism node is a terminal edge, the agent identification system can transmit instructions to cause a set of interventions to be applied to the target system. Each of these interventions differs only in the modification applied to the variable element represented by the object-level node corresponding to the second mechanism node. The agent identification system then determines, based on the response of the target system to interventions, whether the edge is a terminal edge. For instance, in a simplified case, the agent identification system can determine that the edge is a terminal edge if the response of the nodes connected by the edge is non-constant over the applied interventions.

The agent identification system determines, for each of one or more object-level nodes, that the object-level node satisfies a criterion based on a terminal edge connected to the object-level node (332). For instance, the agent identification system can determine that the criterion is satisfied for an object-level node if the model of the target system includes an outgoing terminal edge from the mechanism node for the object-level node to the mechanism node for a different object-level node that represents a decision element.

The system identifies each variable element represented by an object-level node that satisfies the criterion as being a utility element (334).

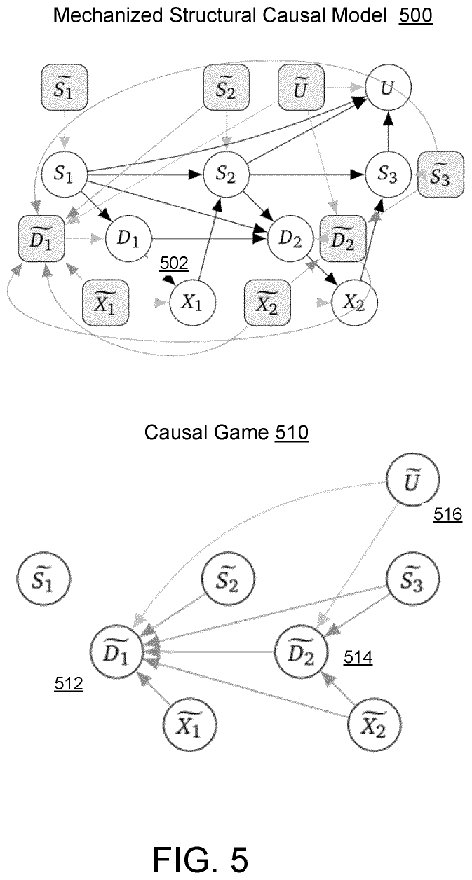

FIG. 4 shows a target system that includes an agent 404 interacting with an environment 406. The agent is controlled by an action selection system 400, which can be implemented as computer programs on one or more computers in one or more locations. The agent identification system can identify one or more agents in the environment, i.e., in addition to the agent 404. Examples of the agent identification system identifying one or more agents in example target action selection systems will be covered in FIGS. 5 and 6.

The action selection system 400 is an example of a system that can control an agent 404 interacting with an environment 406 to perform a task in the environment 406. At each time step, the system receives an input observation 410 and selects an action 404 from a set of actions for the agent to perform. For example, the set of actions can include a fixed number of actions or can be a continuous action space.

The action selection system 400 controls an agent 404 interacting with an environment 406 to accomplish a task by selecting actions 408 to be performed by the agent 404 at each of multiple (environment) time steps during the performance of an episode of the task. In terms of the agent identification framework, the actions the agent makes are decisions taken to achieve the task and completing the task is associated with maximizing the agent's utility.

As a general example, the task can include one or more of, e.g., navigating to a specified location in the environment 104, identifying a specific object in the environment 406, manipulating the specific object in a specified way, controlling items of equipment to satisfy criteria, distributing resources across devices, and so on. More generally, the task is specified by received rewards 430, i.e., such that an episodic return is maximized when the task is successfully completed. Rewards and returns are closely associated with utility, and both will be described in more detail below. Examples of agents, tasks, and environments are also provided below.

An “episode” of a task is a sequence of interactions during which the agent 404 attempts to perform a single instance of the task starting from some starting state of the environment 406. In other words, each task episode begins with the environment 406 being in an initial state, e.g., a fixed initial state or a randomly selected initial state, and ends when the agent 404 has successfully completed the task (maximized utility) or when some termination criterion is satisfied, e.g., the environment 406 enters a state that has been designated as a terminal state or the agent 404 performs a threshold number of actions 408 without successfully completing the task.

At each (environment) time step during any given task episode, the system 400 receives an observation 410 characterizing the current state of the environment 406 at the time step and, in response, selects an action 408 to be performed by the agent 404 at the time step. A time step at which the system selects an action 408 for the agent 404 to perform may be referred to as an environment time step. After the agent 404 performs the action 408, the environment 406 transitions into a new state and the system 400 receives both a reward 130 and a new observation 410 from the environment 406.

Generally, the reward 430 is a scalar numerical value (that may be zero) and characterizes the progress of the agent 404 towards completing the task.

As a particular example, the reward 430 can be a sparse binary reward that is zero unless the task is successfully completed and utility is maximized as a result of the action 408 being performed, i.e., is only non-zero, e.g., equal to one, if the task is successfully completed as a result of the action 408 performed.

As another particular example, the reward 430 can be a dense reward that measures a progress of the agent 404 towards completing the task as of individual observations 410 received during the episode of attempting to perform the task, i.e., so that non-zero rewards can be and frequently are received before the task is successfully completed. This reward approach accumulates utility over time.

While performing any given task episode, the system 400 selects actions 408 in order to attempt to maximize a return that is received over the course of the task episode. A return refers to a cumulative measure of “rewards” (utility) received by the agent, for example, a time-discounted sum of rewards over task episodes.

That is, at each time step during the episode, the system 400 selects actions 408 that attempt to maximize the return that will be received for the remainder of the task episode starting from the time step.

Generally, at any given time step, the return that will be received is a combination of the rewards 430 that will be received at time steps that are after the given time step in the episode, thereby accumulating utility over time.

For example, at a time step t, the return can satisfy:

$${\sum }_{i} {γ}^{i - t - 1} {r}_{i} ,$$

where i ranges either over all of the time steps after t in the episode or for some fixed number of time steps after t within the episode, γ is a discount factor that is greater than zero and less than or equal to one, and rᵢ is the reward at time step i. This equation accumulates over time.

To control the agent 408 at the first time step, the system 400 receives an observation 410 characterizing a state of the environment at the first time step.

To control the agent, at each time step in the episode, a base policy subsystem 402 of the system 400 uses a base policy neural network 403 to select the action 408 that will be performed by the agent 404 at the time step. This action constitutes the agent's decision.

In particular, the base policy subsystem 402 uses the base policy neural network 403 to process the observation 410 to generate a base policy output and can then use the base policy output to select the action 408 to be performed by the agent 404 at the time step.

The base policy network 403 can generally have any appropriate neural network architecture that enables it to perform its described functions, e.g., processing an input that includes an observation 410 of the current state of the environment 406 to generate an output that characterizes an action to be performed by the agent 404 in response to the observation 410. The base policy network 403 may be a neural network system that includes multiple neural networks that cooperate to generate the output.

For example, the deep neural network can include any appropriate number of layers (e.g., 5 layers, 10 layers, or 25 layers) of any appropriate type (e.g., fully connected layers, convolutional layers, attention layers, transformer layers, recurrent layers etc.) and connected in any appropriate configuration (e.g., as a linear sequence of layers).

In one example, the base policy output may include a respective numerical probability value for each action in the fixed set of actions. The system 402 can select the action 408, e.g., by sampling an action in accordance with the probability values for the action indices, or by selecting the action with the highest probability value.

In another example, the base policy output may include a respective Q-value for each action in the fixed set of actions. The system 402 can process the Q-values (e.g., using a soft-max function) to generate a respective probability value for each action, which can be used to select the action 408 (as described earlier), or can select the action with the highest Q-value.

The Q-value for an action is an estimate of a return that would result from the agent 404 performing the action 408 in response to the current observation 410 and thereafter selecting future actions 408 performed by the agent 404 in accordance with current values of base policy neural network parameters of the base policy network 403.

As another example, when the action space is continuous, the policy output can include parameters of a probability distribution over the continuous action space and the system 402 can select the action 408 by sampling from the probability distribution or by selecting the mean action. A continuous action space is one that contains an uncountable number of actions, i.e., where each action is represented as a vector having one or more dimensions and, for each dimension, the action vector can take any value that is within the range for the dimension and the only constraint is the precision of the numerical format used by the system 400.

As yet another example, when the action space is continuous the policy output can include a regressed action, i.e., a regressed vector representing an action from the continuous space, and the system 402 can select the regressed action as the action 408.

Prior to using the base policy network 403 to control the agent 404, a training subsystem 405 within the system 400 can train the base policy network 403.

In some implementations, the environment is a real-world environment, the agent is a mechanical agent interacting with the real-world environment, e.g., a robot or an autonomous or semi-autonomous land, air, or sea vehicle operating in or navigating through the environment, and the actions are actions taken by the mechanical agent in the real-world environment to perform the task. For example, the agent may be a robot interacting with the environment to accomplish a specific task, e.g., to locate an object of interest in the environment or to move an object of interest to a specified location in the environment or to navigate to a specified destination in the environment.

In these implementations, the observations may include, e.g., one or more of: images, object position data, and sensor data to capture observations as the agent interacts with the environment, for example sensor data from an image, distance, or position sensor or from an actuator. For example in the case of a robot, the observations may include data characterizing the current state of the robot, e.g., one or more of: joint position, joint velocity, joint force, torque or acceleration, e.g., gravity-compensated torque feedback, and global or relative pose of an item held by the robot. In the case of a robot or other mechanical agent or vehicle the observations may similarly include one or more of the position, linear or angular velocity, force, torque or acceleration, and global or relative pose of one or more parts of the agent. The observations may be defined in 1, 2 or 3 dimensions, and may be absolute and/or relative observations. The observations may also include, for example, sensed electronic signals such as motor current or a temperature signal; and/or image or video data for example from a camera or a LIDAR sensor, e.g., data from sensors of the agent or data from sensors that are located separately from the agent in the environment.

In these implementations, the actions may be control signals to control the robot or other mechanical agent, e.g., torques for the joints of the robot or higher-level control commands, or the autonomous or semi-autonomous land, air, sea vehicle, e.g., torques to the control surface or other control elements e.g., steering control elements of the vehicle, or higher-level control commands. The control signals can include for example, position, velocity, or force/torque/acceleration data for one or more joints of a robot or parts of another mechanical agent. The control signals may also or instead include electronic control data such as motor control data, or more generally data for controlling one or more electronic devices within the environment the control of which has an effect on the observed state of the environment. For example in the case of an autonomous or semi-autonomous land or air or sea vehicle the control signals may define actions to control navigation, e.g., steering, and movement, e.g., braking and/or acceleration of the vehicle.

In some implementations the environment is a simulation of the above-described real-world environment, and the agent is implemented as one or more computers interacting with the simulated environment. For example the simulated environment may be a simulation of a robot or vehicle and the reinforcement learning system may be trained on the simulation and then, once trained, used in the real-world.

In some implementations the environment is a real-world manufacturing environment for manufacturing a product, such as a chemical, biological, or mechanical product, or a food product. As used herein a “manufacturing” a product also includes refining a starting material to create a product, or treating a starting material, e.g., to remove pollutants, to generate a cleaned or recycled product. The manufacturing plant may comprise a plurality of manufacturing units such as vessels for chemical or biological substances, or machines, e.g., robots, for processing solid or other materials. The manufacturing units are configured such that an intermediate version or component of the product is moveable between the manufacturing units during manufacture of the product, e.g., via pipes or mechanical conveyance. As used herein manufacture of a product also includes manufacture of a food product by a kitchen robot.

The agent may comprise an electronic agent configured to control a manufacturing unit, or a machine such as a robot, that operates to manufacture the product. That is, the agent may comprise a control system configured to control the manufacture of the chemical, biological, or mechanical product. For example the control system may be configured to control one or more of the manufacturing units or machines or to control movement of an intermediate version or component of the product between the manufacturing units or machines.

As one example, a task performed by the agent may comprise a task to manufacture the product or an intermediate version or component thereof. As another example, a task performed by the agent may comprise a task to control, e.g., minimize, use of a resource such as a task to control electrical power consumption, or water consumption, or the consumption of any material or consumable used in the manufacturing process.

The actions may comprise control actions to control the use of a machine or a manufacturing unit for processing a solid or liquid material to manufacture the product, or an intermediate or component thereof, or to control movement of an intermediate version or component of the product within the manufacturing environment, e.g., between the manufacturing units or machines. In general the actions may be any actions that have an effect on the observed state of the environment, e.g., actions configured to adjust any of the sensed parameters described below. These may include actions to adjust the physical or chemical conditions of a manufacturing unit, or actions to control the movement of mechanical parts of a machine or joints of a robot. The actions may include actions imposing operating conditions on a manufacturing unit or machine, or actions that result in changes to settings to adjust, control, or switch on or off the operation of a manufacturing unit or machine.

The rewards or return may relate to a metric of performance of the task. For example in the case of a task that is to manufacture a product the metric may comprise a metric of a quantity of the product that is manufactured, a quality of the product, a speed of production of the product, or to a physical cost of performing the manufacturing task, e.g., a metric of a quantity of energy, materials, or other resources, used to perform the task. In the case of a task that is to control use a resource the matric may comprise any metric of usage of the resource.

In general observations of a state of the environment may comprise any electronic signals representing the functioning of electronic and/or mechanical items of equipment. For example a representation of the state of the environment may be derived from observations made by sensors sensing a state of the manufacturing environment, e.g., sensors sensing a state or configuration of the manufacturing units or machines, or sensors sensing movement of material between the manufacturing units or machines. As some examples such sensors may be configured to sense mechanical movement or force, pressure, temperature; electrical conditions such as current, voltage, frequency, impedance; quantity, level, flow/movement rate or flow/movement path of one or more materials; physical or chemical conditions, e.g., a physical state, shape or configuration or a chemical state such as pH; configurations of the units or machines such as the mechanical configuration of a unit or machine, or valve configurations; image or video sensors to capture image or video observations of the manufacturing units or of the machines or movement; or any other appropriate type of sensor. In the case of a machine such as a robot the observations from the sensors may include observations of position, linear or angular velocity, force, torque or acceleration, or pose of one or more parts of the machine, e.g., data characterizing the current state of the machine or robot or of an item held or processed by the machine or robot. The observations may also include, for example, sensed electronic signals such as motor current or a temperature signal, or image or video data for example from a camera or a LIDAR sensor. Sensors such as these may be part of or located separately from the agent in the environment.

In some implementations the environment is the real-world environment of a service facility comprising a plurality of items of electronic equipment, such as a server farm or data center, for example a telecommunications data center, or a computer data center for storing or processing data, or any service facility. The service facility may also include ancillary control equipment that controls an operating environment of the items of equipment, for example environmental control equipment such as temperature control, e.g., cooling equipment, or air flow control or air conditioning equipment. The task may comprise a task to control, e.g., minimize, use of a resource, such as a task to control electrical power consumption, or water consumption. The agent may comprise an electronic agent configured to control operation of the items of equipment, or to control operation of the ancillary, e.g., environmental, control equipment.

In general the actions may be any actions that have an effect on the observed state of the environment, e.g., actions configured to adjust any of the sensed parameters described below. These may include actions to control, or to impose operating conditions on, the items of equipment or the ancillary control equipment, e.g., actions that result in changes to settings to adjust, control, or switch on or off the operation of an item of equipment or an item of ancillary control equipment.

In general observations of a state of the environment may comprise any electronic signals representing the functioning of the facility or of equipment in the facility. For example a representation of the state of the environment may be derived from observations made by any sensors sensing a state of a physical environment of the facility or observations made by any sensors sensing a state of one or more of items of equipment or one or more items of ancillary control equipment. These include sensors configured to sense electrical conditions such as current, voltage, power or energy; a temperature of the facility; fluid flow, temperature or pressure within the facility or within a cooling system of the facility; or a physical facility configuration such as whether or not a vent is open.

The rewards or return may relate to a metric of performance of the task. For example in the case of a task to control, e.g., minimize, use of a resource, such as a task to control use of electrical power or water, the metric may comprise any metric of use of the resource.

In some implementations the environment is the real-world environment of a power generation facility, e.g., a renewable power generation facility such as a solar farm or wind farm. The task may comprise a control task to control power generated by the facility, e.g., to control the delivery of electrical power to a power distribution grid, e.g., to meet demand or to reduce the risk of a mismatch between elements of the grid, or to maximize power generated by the facility. The agent may comprise an electronic agent configured to control the generation of electrical power by the facility or the coupling of generated electrical power into the grid. The actions may comprise actions to control an electrical or mechanical configuration of an electrical power generator such as the electrical or mechanical configuration of one or more renewable power generating elements, e.g., to control a configuration of a wind turbine or of a solar panel or panels or mirror, or the electrical or mechanical configuration of a rotating electrical power generation machine. Mechanical control actions may, for example, comprise actions that control the conversion of an energy input to an electrical energy output, e.g., an efficiency of the conversion or a degree of coupling of the energy input to the electrical energy output. Electrical control actions may, for example, comprise actions that control one or more of a voltage, current, frequency or phase of electrical power generated.

The rewards or return may relate to a metric of performance of the task. For example in the case of a task to control the delivery of electrical power to the power distribution grid the metric may relate to a measure of power transferred, or to a measure of an electrical mismatch between the power generation facility and the grid such as a voltage, current, frequency or phase mismatch, or to a measure of electrical power or energy loss in the power generation facility. In the case of a task to maximize the delivery of electrical power to the power distribution grid the metric may relate to a measure of electrical power or energy transferred to the grid, or to a measure of electrical power or energy loss in the power generation facility.

In general observations of a state of the environment may comprise any electronic signals representing the electrical or mechanical functioning of power generation equipment in the power generation facility. For example a representation of the state of the environment may be derived from observations made by any sensors sensing a physical or electrical state of equipment in the power generation facility that is generating electrical power, or the physical environment of such equipment, or a condition of ancillary equipment supporting power generation equipment. Such sensors may include sensors configured to sense electrical conditions of the equipment such as current, voltage, power or energy; temperature or cooling of the physical environment; fluid flow; or a physical configuration of the equipment; and observations of an electrical condition of the grid, e.g., from local or remote sensors. Observations of a state of the environment may also comprise one or more predictions regarding future conditions of operation of the power generation equipment such as predictions of future wind levels or solar irradiance or predictions of a future electrical condition of the grid.

As another example, the environment may be a chemical synthesis or protein folding environment such that each state is a respective state of a protein chain or of one or more intermediates or precursor chemicals and the agent is a computer system for determining how to fold the protein chain or synthesize the chemical. In this example, the actions are possible folding actions for folding the protein chain or actions for assembling precursor chemicals/intermediates and the result to be achieved may include, e.g., folding the protein so that the protein is stable and so that it achieves a particular biological function, e.g. to define a specific binding site e.g. of a drug or drug target or for an agonist or antagonist of a receptor or enzyme, or so that it provides a valid synthetic route for the chemical. As another example, the agent may include a mechanical agent that performs or controls synthesis of the protein, e.g. by automatically selecting amino acids in a sequence of amino acids that makes up the protein, or by performing chemical synthesis steps selected by the system automatically without human interaction. The observations may comprise direct or indirect observations of a state of the protein or chemical/intermediates/precursors and/or may be derived from simulation.

In a similar way the environment may be a drug design environment such that each state is a respective state of a potential pharmaceutically active compound and the agent is a computer system for determining elements of the pharmaceutically active compound and/or a synthetic pathway for the pharmaceutically active compound. The drug/synthesis may be designed based on a reward derived from a target for the drug, for example in simulation. As another example, the agent may be a mechanical agent that performs or controls synthesis of the drug.

In some further applications, the environment is a real-world environment and the agent is a software agent that performs the task of managing the distribution of computing tasks across computing resources, e.g., on a mobile device and/or in a data center. In these implementations, the observations may include observations of computing resources such as compute and/or memory capacity, or Internet-accessible resources, and the actions may include assigning computing tasks to particular computing resources. The reward(s) may relate to one or more metrics of processing the computing tasks using the computing resources, e.g. metrics of usage of computational resources, bandwidth, or electrical power, or metrics of processing time, or numerical accuracy, or one or more metrics that relate to a desired load balancing between the computing resources.

As another example the environment may comprise a real-world computer system or network, the observations may comprise any observations characterizing operation of the computer system or network, the actions performed by the software agent may comprise actions to control the operation e.g. to limit or correct abnormal or undesired operation e.g. because of the presence of a virus or other security breach, and the reward(s) may comprise any metric(s) that characterizing desired operation of the computer system or network

In some applications the environment is a data packet communications network environment, and the agent is part of a router to route packets of data over the communications network. The actions may comprise data packet routing actions and the observations may comprise e.g. observations of a routing table which includes routing metrics such as a metric of routing path length, bandwidth, load, hop count, path cost, delay, maximum transmission unit (MTU), and reliability. The reward(s) may be defined in relation to one or more of the routing metrics i.e. configured to maximize one or more of the routing metrics.

As further example, the actions may include presenting advertisements, the observations may include advertisement impressions or a click-through count or rate, and the reward may characterize previous selections of items or content taken by one or more users.

In some cases, the observations may include textual or spoken instructions provided to the agent by a third-party (e.g., an operator of the agent). For example, the agent may be an autonomous vehicle, and a user of the autonomous vehicle may provide textual or spoken instructions to the agent (e.g., to navigate to a particular location).

As another example the environment may be an electrical, mechanical or electro-mechanical design environment, e.g., an environment in which the design of an electrical, mechanical or electro-mechanical entity is simulated. The simulated environment may be a simulation of a real-world environment in which the entity is intended to work. The task may be to design the entity. The observations may comprise observations that characterize the entity, i.e., observations of a mechanical shape or of an electrical, mechanical, or electro-mechanical configuration of the entity, or observations of parameters or properties of the entity. The actions may comprise actions that modify the entity, e.g., that modify one or more of the observations. The rewards or return may comprise one or more metric of performance of the design of the entity. For example rewards or return may relate to one or more physical characteristics of the entity such as weight or strength or to one or more electrical characteristics of the entity such as a measure of efficiency at performing a particular function for which the entity is designed. The design process may include outputting the design for manufacture, e.g., in the form of computer executable instructions for manufacturing the entity. The process may include making the entity according to the design. Thus a design an entity may be optimized, e.g., by reinforcement learning, and then the optimized design output for manufacturing the entity, e.g., as computer executable instructions; an entity with the optimized design may then be manufactured.

As previously described the environment may be a simulated environment. Generally in the case of a simulated environment the observations may include simulated versions of one or more of the previously described observations or types of observations and the actions may include simulated versions of one or more of the previously described actions or types of actions. For example the simulated environment may be a motion simulation environment, e.g., a driving simulation or a flight simulation, and the agent may be a simulated vehicle navigating through the motion simulation. In these implementations, the actions may be control inputs to control the simulated user or simulated vehicle. Generally the agent may be implemented as one or more computers interacting with the simulated environment.

The simulated environment may be a simulation of a particular real-world environment and agent. For example, the system may be used to select actions in the simulated environment during training or evaluation of the system and, after training, or evaluation, or both, are complete, may be deployed for controlling a real-world agent in the particular real-world environment that was the subject of the simulation. This can avoid unnecessary wear and tear on and damage to the real-world environment or real-world agent and can allow the control neural network to be trained and evaluated on situations that occur rarely or are difficult or unsafe to re-create in the real-world environment. For example the system may be partly trained using a simulation of a mechanical agent in a simulation of a particular real-world environment, and afterwards deployed to control the real mechanical agent in the particular real-world environment. Thus in such cases the observations of the simulated environment relate to the real-world environment, and the selected actions in the simulated environment relate to actions to be performed by the mechanical agent in the real-world environment.

For example, in some implementations the described system is used in a simulation of a real-world environment to generate training data as described, i.e. using the base policy neural network and the exploration strategy, to control a simulated version of the agent to perform actions in the simulated environment, and collecting training data comprising, e.g. tuples of an observation, an action performed in response to the observation, and a reward received. The described method or system may then be deployed in the real-world environment, and used to select actions performed by the agent to interact with the environment to perform a particular task. The real-world environment, and agent, may be, e.g. any of those described above.

Optionally, in any of the above implementations, the observation at any given time step may include data from a previous time step that may be beneficial in characterizing the environment, e.g., the action performed at the previous time step, the reward received at the previous time step, or both.

FIG. 5 demonstrates the application of the agent identification system to an example Markov Decision Process (MDP). The MDP can be implemented as part of the base policy of the agent in the action selection system of FIG. 4.

In particular, the example MDP is a modified action MDP, meaning the agent's decision Dt can be overridden by a human at every time step t. This randomness is represented by a chance variable Xₜ, which represents the potentially overridden decision at a time step t.

In an example, an agent identification system can apply interventions to the modified action MDP action selection system and collect data that can be processed to generate a causal model that can be used for agent identification. In particular, Algorithm 2 can be used to generate the mechanized causal graph 500 and Algorithm 3 can be used to generate the causal game 510 used for agent identification.

As an example of how these two algorithms connect: Algorithm 2 identifies the nodes and edges of the structural causal model. In particular, it identifies the edge 502 between (X₁, D₁), meaning that the decision rule that the agent selects is influenced by the mechanism for the potentially overridden variable, X₁. Algorithm 3 then defines that D₁ 512 and D₂ 514 are decision nodes since they have incoming arrows, and then defines that U 516 is a utility node since it has a mechanism with an outgoing terminal edge to decisions D₁ 512 and D₂ 514. Since the decisions lead to the same utility, they may come from the same agent.

FIG. 6 demonstrates the output of an agent identification system for an actor-critic reinforcement learning method. The actor-critic method can be implemented by the action selection system of FIG. 4.

More specifically, the actor-critic method involves multiple agents, specifically an actor-agent selecting an action A as advised by a critic. The critic's action Q is a vector that assigns an expected reward produced by that action to each possible action A. The next state S depends on the actor's action A, and the reward R depends on this state. As discussed in FIG. 4, this is a Q-value function. The actor's utility Y therefore corresponds to the Q-value for each action. The actor-critic agent then has utility W=−(R−Y)², meaning the agent's Q-value function aims to match the reward.

In one example, the agent identification system can apply Algorithm 2 to generate the mechanized structural causal graph 600 and Algorithm 3 to generate the causal game 610. Several example details of how the algorithm relates to the target system are described below.

As an example, Algorithm 2 specifies that edge 602 between (\tilde{S}, \tilde{Q}) is drawn, but (\tilde{S}, Ã) is not. This is because the target system is optimizing for W, which is causally affected by S (as it is a child node of S), and so the optimal decision rule for A will adapt if there is a change in the mechanism for Q, with other mechanisms intervened and held constant.

In particular, in order to figure out that edge 602 exists but an edge between (\tilde{S}, Ã) does not, the agent identification system can define an intervention on the mechanism of Q, which is a decision rule. This means the system can remove the incoming edges to Q, therefore removing Q's dependence on parent nodes, and assess whether changing the mechanism for S affects the optimal decision rule for A. The response data can indicate that A is not dependent on Q, since A only cares about optimizing Y, whose distribution is unaffected when the mechanism for Q is held constant hence the lack of edge (\tilde{S}, Ã). There is however an indirect effect of the mechanism for S on the decision rule for A, which is mediated through the decision rule for Q.

As another example, Algorithm 3 can identify that Ã and \tilde{Q} have incoming arrows, and therefore are decisions; that Y's mechanism has an outgoing terminal edge to A's mechanism and so is its utility; and that W's mechanism has an outgoing terminal edge to the mechanism for Q, and so is its utility.

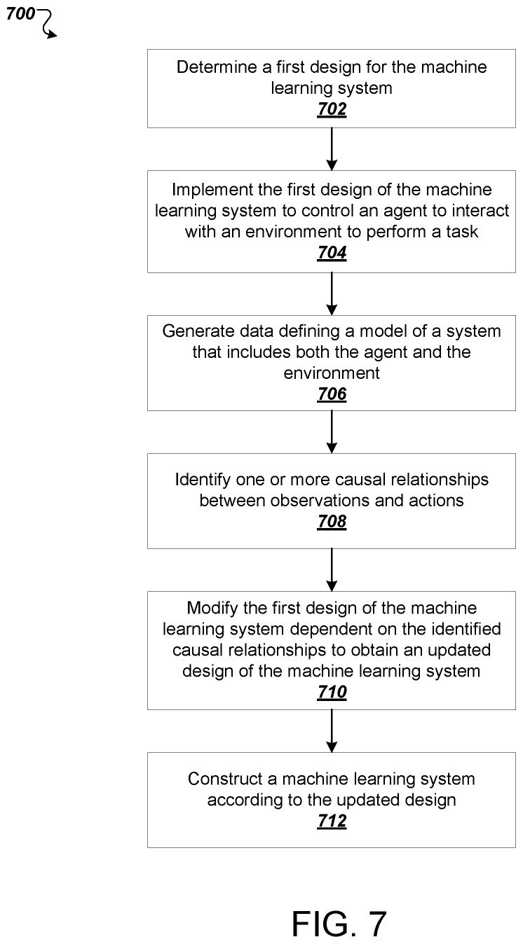

FIG. 7 is a flow diagram of an example process 700 for constructing a machine learning system that learns an action selection policy for controlling an agent to interact with an environment to perform a task. The machine learning system is configured to, at each time step in a sequence of time steps: (i) receive a current observation characterizing a state of the environment at the time step, and (ii) process the current observation to select an action to be performed by the agent in response to the current observation using the action control policy. For convenience, the process 700 will be described as being performed by a system of one or more computers in one or more locations.

The system determines a first design for the machine learning system (702).

The system implements the first design of the machine learning system to control the agent to interact with the environment to perform the task (704).

The system uses the agent identification system to generate the data defining a model of a target system that includes the agent and the environment (706). The model of the target system includes a set of nodes and a set of edges that jointly define a causal graph. The current observation determines values for one or more of the variable elements. The agent identification system uses the model to obtain the data that identifies the one or more agents in the target system.

The system uses one or both of the causal graph and the data that identifies the one or more agents in the target system to identify one or more causal relationships between the observations processed by the machine learning system and the actions selected by the machine learning system (708).

The system modifies the first design of the machine learning system dependent on the identified causal relationships to obtain an updated design of the machine learning system (710).

The system constructs a machine learning system according to the updated design (712).

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method performed by one or more computers, the method comprising:
receiving a request to identify one or more agents in a system, wherein each agent is an entity that interacts with the system by performing actions that are selected in accordance with an action selection policy; and
in response to the receiving the request:
generating data defining a model of the system, comprising:
generating data defining a set of nodes, wherein each node represents a respective variable element of the system; and
generating data defining a set of edges, wherein each edge represents a relationship between a respective pair of variable elements of the system, and wherein generating the set of edges comprises:
transmitting instructions to cause a plurality of interventions to be applied to the system, wherein each intervention modifies one or more variable elements in the system; and
obtaining response data that defines a respective response of the system to each of the plurality of interventions that are applied to the system; and
processing the response data to generate the set of edges; and
processing the model of the system to identify one or more of the variable elements in the system as being decision elements, wherein each decision element represents an action selected by a respective agent in the system;
identifying one or more agents in the system based on the decision elements; and
outputting data that identifies the agents in the system.

2. The method of claim 1, wherein the plurality of interventions comprise a set of interventions corresponding to a pair of nodes comprising a first node and a second node; and
wherein processing the response data to generate the set of edges comprises:
determining whether the pair of nodes is connected by an edge based on the response data for set of interventions corresponding to the pair of nodes.

3. The method of claim 2, wherein the set of interventions corresponding to the pair of nodes comprising the first node and the second node comprises a plurality of interventions that differ only in the modification applied to the variable element represented by the first node.

4. The method of claim 3, wherein determining whether the pair of nodes is connected by an edge based on the response data for the set of interventions corresponding to the pair of nodes comprises:
determining that a response of the second node is not constant over the set of interventions corresponding to the pair of nodes; and
in response, determining that an edge connects the first node to the second node.

5. The method of claim 1, wherein the set of nodes comprises: (i) a plurality of nodes designated as object-level nodes, and (ii) a plurality of nodes designated as first mechanism nodes, wherein each first mechanism node corresponds to a respective object-level node and represents a model for a behavior of the variable element represented by the object-level node.

6. The method of claim 5, wherein processing the model of the system to identify one or more of the variable elements in the system as being decision elements comprises, for one or more object-level nodes:
determining that the mechanism node corresponding to the object-level node receives an incoming edge from a different mechanism node; and
in response, identifying the variable element represented by the object-level node as being a decision element.

7. The method of claim 5, wherein the set of nodes further comprises: (iii) a plurality of nodes designated as second mechanism nodes, wherein each second mechanism node corresponds to a decision rule node representing the action selection policy of one of the agents, and wherein one or more of the second mechanism nodes receives an incoming edge from one or more of the first mechanism nodes.

8. The method of claim 5, further comprising modifying at least one variable element represented by an object-level node with one of the interventions.

9. The method of claim 5, further comprising:
processing the model of the system to identify one or more of the variable elements in the system as being utility elements, wherein each utility element represents an element that is an optimization target for one or more agents in the system.

10. The method of claim 9, wherein processing the model of the system to identify one or more of the variable elements in the system as being utility elements comprises:
identifying each of one or more edges in the set of edges as being terminal edges; and
for each of one or more object-level nodes:
determining that the model of the system includes an outgoing terminal edge from the mechanism node for the object-level node to the mechanism node for a different object-level node that represents a decision element; and
in response, identifying the variable element represented by the object-level node as being a utility element.

11. The method of claim 10, wherein identifying each of one or more edges in the set of edges as being terminal edges comprises, for each edge that is identified as being a terminal edge:
determining that the edge connects a first mechanism node to a second mechanism node; and
transmitting instructions to cause a plurality of interventions to be applied to the system, wherein each of the plurality of interventions differ only in the modification applied to the variable element represented by the object-level node corresponding to the second mechanism node.

12. The method of claim 10, further comprising, for each decision element in the system, identifying a corresponding utility element that is an optimization target for the decision element.

13. The method of claim 12, wherein for each decision element, identifying the corresponding utility element that is an optimization target for the decision element comprises:
identifying, as the corresponding utility element, an element that is represented by an object-level node having a corresponding mechanism node that is connected to the mechanism node for the decision element by a terminal edge.

14. The method of claim 1, wherein identifying one or more agents in the system based on the decision elements comprises:
determining that the system includes a respective agent corresponding to each decision element, wherein the agent corresponding to a decision element selects the action represented by the decision element.

15. The method of claim 1, wherein for each of the plurality of interventions that are applied to the system, obtaining response data that defines a respective response of the system to the intervention comprises:
obtaining a respective value of each variable element of the system after the system is modified in accordance with the intervention applied to the system.

16. The method of claim 1, wherein the system is a computer-implemented simulation of a real-world system.

17. The method of claim 16, wherein the real-world system comprises an electrical system.

18. (canceled)

19. (canceled)

20. The method of claim 1, wherein the system is a software system.

21. (canceled)

22. (canceled)

23. (canceled)

24. (canceled)

25. (canceled)

26. A system comprising:
one or more computers; and
one or more storage devices communicatively coupled to the one or more computers, wherein the one or more storage devices store instructions that, when executed by the one or more computers, cause the one or more computers to perform operations comprising:
receiving a request to identify one or more agents in a system, wherein each agent is an entity that interacts with the system by performing actions that are selected in accordance with an action selection policy; and
in response to the receiving the request:
generating data defining a model of the system, comprising:
generating data defining a set of nodes, wherein each node represents a respective variable element of the system; and
generating data defining a set of edges, wherein each edge represents a relationship between a respective pair of variable elements of the system, and wherein generating the set of edges comprises:
transmitting instructions to cause a plurality of interventions to be applied to the system, wherein each intervention modifies one or more variable elements in the system; and
obtaining response data that defines a respective response of the system to each of the plurality of interventions that are applied to the system; and
processing the response data to generate the set of edges; and
processing the model of the system to identify one or more of the variable elements in the system as being decision elements, wherein each decision element represents an action selected by a respective agent in the system;
identifying one or more agents in the system based on the decision elements; and
outputting data that identifies the agents in the system.

27. One or more non-transitory computer storage media storing instructions that when executed by one or more computers cause the one or more computers to perform operations comprising:
receiving a request to identify one or more agents in a system, wherein each agent is an entity that interacts with the system by performing actions that are selected in accordance with an action selection policy; and
in response to the receiving the request:
generating data defining a model of the system, comprising:
generating data defining a set of nodes, wherein each node represents a respective variable element of the system; and
generating data defining a set of edges, wherein each edge represents a relationship between a respective pair of variable elements of the system, and wherein generating the set of edges comprises:
transmitting instructions to cause a plurality of interventions to be applied to the system, wherein each intervention modifies one or more variable elements in the system; and
obtaining response data that defines a respective response of the system to each of the plurality of interventions that are applied to the system; and
processing the response data to generate the set of edges; and
processing the model of the system to identify one or more of the variable elements in the system as being decision elements, wherein each decision element represents an action selected by a respective agent in the system;
identifying one or more agents in the system based on the decision elements; and
outputting data that identifies the agents in the system.
